(19) United States
(12) Patent Application Publication
(10) Pub. No.: US 2009/0169044 A1
(43) Pub. Date: Jul. 2, 2009

(54) Earphone Antenna

(76) Inventors: Takayoshi Kashiwagi, Tokyo (JP); Akihiro Ohshima, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/085,301

(22) PCT Filed: Aug. 29, 2006
(86) PCT No.: PCT/JP2006/316959

§ 371 Date: May 21, 2008

(30) Foreign Application Priority Data
Nov. 24, 2005 (JP) 2005-338066

(51) Int. Cl. H04R 1/00

(52) U.S. Cl. 381/384

(57) ABSTRACT

An object is to efficiently receive a radio wave in a high-frequency band of a UHF band. An earphone antenna (20) includes a connector (21) to be connected to an electronic device, a switch (22), earphones (25L, 25R), a first cable (23) for connecting the connector and the switch, and a connecting member for connecting the switch and the earphones. The connecting member is composed of an earphone jack unit (24), second cables (26) for connecting the earphone jack unit and the earphones, and a third cable (27) for connecting the switch and the earphone jack unit. The third cable (27) is used as an antenna.

### TECHNICAL FIELD

This invention relates to an antenna device and, in particular, relates to an earphone antenna adapted to be connected to a portable terminal device and having an antenna function for receiving a radio wave in the UHF (Ultra High Frequency) band.

### BACKGROUND ART

Recently, some types of portable telephones have been put on the market that allow watching and listening of television broadcasts and FM broadcasts. Further, those portable terminal devices (portable devices) such as portable telephones are being developed that make it possible not only to listen to music, but also to receive terrestrial television broadcast waves to watch and listen to television broadcasts. In the digital terrestrial broadcasting, the frequency band assigned to a broadcasting station is divided into 13 segments. Among them, the 12 segments are used for normal broadcasting services. Mobile reception services for portable telephones and the like are carried out using the remaining one segment. For this reason, such mobile reception services are called one-segment mobile (one-segment broadcasting). NHK and commercial broadcasting companies have started the one-segment broadcasting for portable telephone terminals since Apr. 1, 2006.

As is well known, the television broadcasting based on terrestrial waves or the like uses radio waves in the VHF (Very High Frequency) band or the UHF (Ultra High Frequency) band. The television broadcasting using radio waves in the UHF band uses radio waves in a frequency range of 470 MHz to 770 MHz. Digital terrestrial broadcasts and so on are broadcast using radio waves in the UHF band.

For receiving such various broadcasts, antenna devices are naturally required. In the case of a portable device, a housing or the like is small in size. On the other hand, in an antenna device adapted to receive a radio wave in the FM band (80 MHz), when the antenna length is set to λ4, it becomes as long as about 94 cm, where λ represents a reception wavelength of the radio wave to be received. Thus, the antenna device having such a long antenna length cannot possibly be placed inside the housing.

Therefore, in general, it is widely performed to impart an antenna function to earphones adapted for use in listening to sounds. The earphones having such an antenna function is called antenna built-in earphones, an earphone antenna, or the like.

FIG. 1 shows the configuration of a conventional earphone antenna 10 normally known. The illustrated earphone antenna 10 comprises a connector 11 for connection to a portable telephone (not shown), a switch 12, a first cable (connector-switch cable) 13 connecting the connector 11 and the switch 12 to each other, a pair of earphones 14L and 14R, and second cables (switch-earphone cables) 15 connecting the switch 12 and the earphones 14L and 14R to each other, respectively. The second cables 15 are also called earphone cables.

FIG. 2 is a circuit diagram of the earphone antenna 10 illustrated in FIG. 1. In FIG. 2, illustration of lines (e.g. microphone lines, switch lines, etc.) not associated with the antenna is omitted. The switch 12 comprises a high-frequency separation element 121. The first cable 13 includes a coaxial cable 13-1 for transmitting a received signal, a pair of earphone signal lines 13-2, and an earphone ground line 13-3. The connector 11 comprises an antenna terminal 11-1 connected to a center conductor of the coaxial cable 13-1, an antenna ground terminal 11-2 connected to an outer conductor of the coaxial cable 13-1, a pair of earphone terminals 11-3 connected to the pair of earphone signal lines 13-2, and an earphone ground terminal 11-4 connected to the earphone ground line 13-3.

In the earphone antenna 10 shown in FIG. 1, it is general to use as an antenna the second cables 15 between the switch 12 and the earphones 14L and 14R or to use as an antenna the first cable 13 between the connector 11 and the switch 12.

### DISCLOSURE OF THE INVENTION

### Problem to be Solved by the Invention

However, in the case of the configuration of the earphone antenna 10 shown in FIG. 1, there are the following problems.

At first, it is assumed that the second cables 15 between the switch 12 and the earphones 14L and 14R are used as an antenna. The cable length of the second cable 15 needs to match the general size of a part of the body of a user and thus is inevitably defined by such a general size. However, since the optimal length for broadcast reception is generally λ/4 (λ is a reception wavelength), the optimal length for receiving a radio wave in the UHF band is about 12.5 cm. Therefore, the cable length of the second cable 15 is too long to receive a radio wave in the UHF band. As a result, the radio wave in the UHF band cannot be sufficiently received.

Further, as the switch 12 of the earphone antenna 10, a type has recently been available that has not only a simple sound switching function, but also a remote control function for listening to a broadcast or music stored in a memory of a portable telephone or the like. In the case of such a type, a user often optionally buys earphones in pursuit of his/her own favorite sound quality and so on and enjoys with it. In such a case, even if the user attempts to use the earphones as an antenna, such a user's request cannot be satisfied. The reason is that earphone cables of the earphones optionally bought are not optimally designed for use as an antenna.

Then, it is assumed that the first cable 13 between the connector 11 and the switch 12 is used as an antenna. In this case, replacement of the earphones 14L and 14R becomes possible. However, in order to improve user's use convenience, the cable length of the first cable 13 is normally set in a range of 70 cm to 90 cm. Thus, the cable length of the first cable 13 becomes considerably longer than about 12.5 cm which is the optimal length for receiving, particularly, a radio wave in the UHF band. As a result, there is a problem that the radio wave in the UHF band cannot be satisfactorily received.

It is therefore an object of this invention to provide an earphone antenna that makes it possible to efficiently receive a desired radio wave in a high-frequency band such as the UHF band.

It is another object of this invention to provide an earphone antenna that enables a user to freely select and use an earphone.

### Means for Solving the Problem

According to this invention, in an earphone antenna comprising a connector for connection to an electronic device, a switch, an earphone, a first cable connecting the connector and the switch to each other, and a connecting member connecting the switch and the earphone to each other, the connecting member comprises an earphone jack portion, a second cable connecting the earphone jack portion and the earphone to each other, and a third cable connecting the switch and the earphone jack portion to each other and the third cable is used as an antenna.

In the above-mentioned earphone antenna, the first cable may include a coaxial cable for transmitting a received signal, the third cable may include an antenna element portion having one end connected to a center conductor of the coaxial cable, and the antenna element portion may have a length substantially equal to a quarter of a wavelength of a radio wave to be received. In addition, the radio wave to be received may be, for example, in a UHF band.

The switch may comprise a circuit board receiving the coaxial cable, an outer conductor of the coaxial cable may be ground-connected to the circuit board, and the circuit board may have, from a ground-connected point, a length substantially equal to a quarter of the wavelength of the radio wave to be received. Instead of this, the switch may comprise an additional cable having one end connected to an outer conductor of the coaxial cable and the additional cable may have a length substantially equal to a quarter of the wavelength of the radio wave to be received. Alternatively, the switch may comprise a metal plate having one end connected to an outer conductor of the coaxial cable and the metal plate may have a length substantially equal to a quarter of the wavelength of the radio wave to be received.

The switch may comprise a circuit board and part of the antenna element portion may extend on the circuit board. In this event, the part of the antenna element portion on the circuit board may be a pattern formed on the circuit board.

### EFFECT OF THE INVENTION

In this invention, a connecting member connecting a switch and an earphone to each other comprises an earphone jack portion, a second cable connecting the earphone jack portion and the earphone to each other, and a third cable connecting the switch and the earphone jack portion to each other and the third cable is used as an antenna. Therefore, it becomes possible to efficiently receive a desired radio wave and to allow a user to freely select and use an earphone.

### BRIEF DESCRIPTION OF THE DRAWINGS

FIG. 1 is a perspective view showing an external configuration of a conventional earphone antenna.

FIG. 2 is a circuit diagram showing a circuit configuration of the earphone antenna shown in FIG. 1.

FIG. 3 is a perspective view showing an external configuration of an earphone antenna according to a first embodiment of this invention.

FIG. 4 is a circuit diagram showing a circuit configuration of the earphone antenna shown in FIG. 3.

FIG. 5 is a circuit diagram showing a circuit configuration of an earphone antenna according to a second embodiment of this invention.

FIG. 6 is a perspective view showing a configuration of a sleeve antenna.

FIG. 7 is a diagram showing a schematic configuration of a dipole antenna.

FIG. 8 is a circuit diagram showing a circuit configuration of an earphone antenna according to a third embodiment of this invention.

FIG. 9 is a circuit diagram showing only the main part of the earphone antenna according to each of the first to third embodiments of this invention.

FIG. 10 is a circuit diagram showing a circuit configuration of the main part of an earphone antenna according to a fourth embodiment of this invention.

FIG. 11 is a circuit diagram showing a circuit configuration of the main part of an earphone antenna according to a fifth embodiment of this invention.

### BEST MODE FOR CARRYING OUT THE INVENTION

Hereinbelow, embodiments of this invention will be described in detail with reference to the drawings.

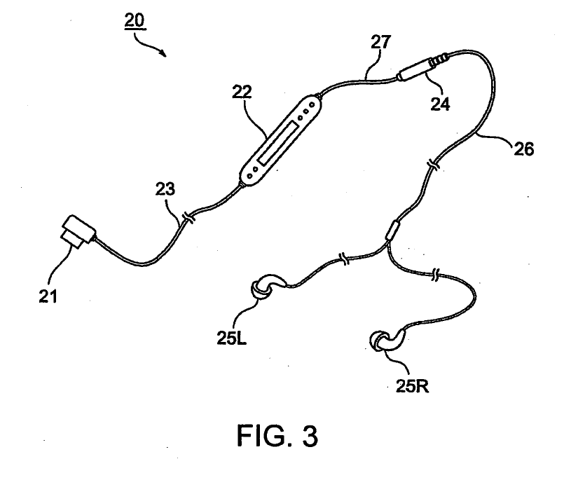

Referring to FIG. 3, an earphone antenna 20 according to a first embodiment of this invention will be described. The illustrated earphone antenna 20 comprises a connector 21 for connection to an electronic device (not shown) such as a portable terminal device like a portable telephone, a switch 22, a first cable (connector-switch cable) 23 connecting the connector 21 and the switch 22 to each other, an earphone jack portion 24, a pair of earphones 25L and 25R, second cables (jack-earphone cables) 26 connecting the earphone jack portion 24 and the earphones 25L and 25R to each other, respectively, and a third cable (switch-jack cable) 27 connecting the switch 22 and the earphone jack portion 24 to each other.

The combination of the earphone jack portion 24, the second cables 26, and the third cable 27 serves as a connecting member connecting the switch 22 and the pair of earphones 25L and 25R to each other.

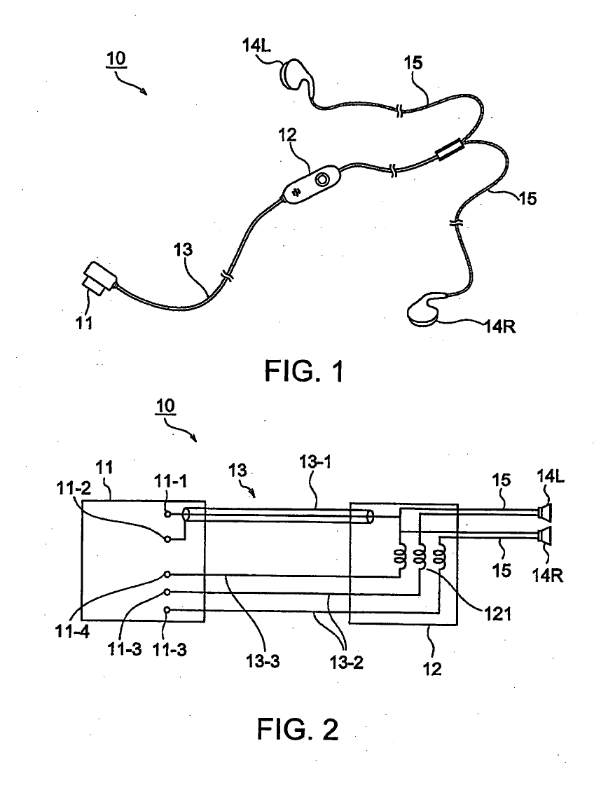

The illustrated switch 22 is in the form of a remote controller. A large difference in shape between the earphone antenna 10 shown in FIG. 1 and the earphone antenna 20 shown in FIG. 3 lies in that the earphone antenna 20 shown in FIG. 3 employs the configuration in which the switch 22 and the earphone jack portion 24 are separated from each other and connected to each other by the third cable 27. Further, in the earphone antenna 20, an antenna cable (described later) is incorporated in the third cable 27.

In the conventional earphone antenna 10, the cables 26 of the earphones 14L and 14R are fixed to the switch 12 as shown in FIG. 1. Alternatively, even if the configuration is such that the cables 26 of the earphones 14L and 14R have a plug and the earphones 14L and 14R are detachable from the switch 12, a jack is incorporated in the switch 12.

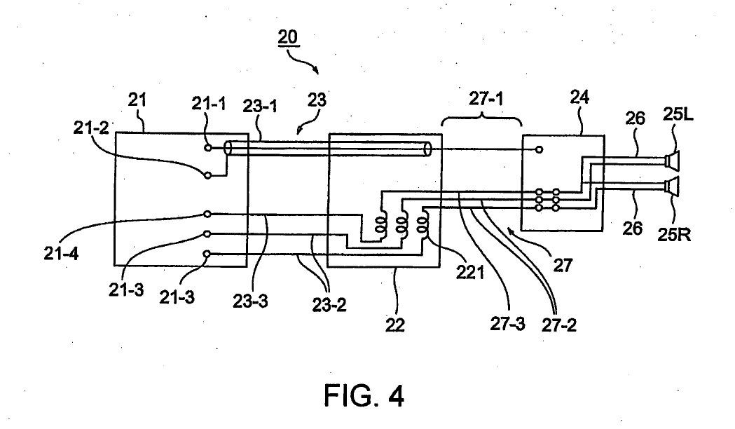

FIG. 4 is a circuit diagram of the earphone antenna 20 illustrated in FIG. 3. In FIG. 4, illustration of lines (e.g. microphone lines, switch lines, etc.) not associated with the antenna is omitted. The switch 22 comprises a high-frequency separation element 221.

The first cable 23 includes a coaxial cable 23-1 for transmitting a received signal, a pair of earphone signal lines 23-2, and an earphone ground line 23-3. The connector 21 comprises an antenna terminal 21-1 connected to a center conductor of the coaxial cable 23-1, an antenna ground terminal 21-2 connected to an outer conductor of the coaxial cable 23-1, a pair of earphone terminals 21-3 connected to the pair of earphone signal lines 23-2, and an earphone ground terminal 21-4 connected to the earphone ground line 23-3.

The third cable 27 includes an antenna element portion 27-1 disposed between the center conductor of the coaxial cable 23-1 accommodated in the switch 22 and the earphone jack portion 24, a pair of earphone signal lines 27-2, and an earphone ground line 27-3. That is, one end of the antenna element portion 27-1 is connected to the center conductor of the coaxial cable 23-1.

The antenna element portion 27-1 may be formed by a simple extension of the center conductor of the coaxial cable 23-1.

By employing the configuration of the earphone antenna 20 illustrated in FIG. 3, the antenna element portion 27-1 having a short length (e.g. about 12.5 cm) can be disposed between the switch 22 and the earphone jack portion 24 as shown in FIG. 4. That is, the antenna element portion 27-1 has a length substantially equal to a quarter of a wavelength of a radio wave to be received. Thus, it becomes possible to efficiently receive a radio wave in a high-frequency band such as the UHF band. On the other hand, a radio wave in a relatively low-frequency band such as the FM band or the VHF band can be received using, for example, the first cable 23 between the connector 21 and the switch 22. At any rate, the earphone antenna 20 illustrated in FIG. 3 can efficiently receive a radio wave in the FM band, the VHF band, or the UHF band between the connector 21 and the earphone jack portion 24.

Further, since the second cables (earphone cables) 26 extending from the earphones 25L and 25R are not used as an antenna element, there is also an advantage in that a user can freely select and use earphones.

At any rate, in the earphone antenna 20 illustrated in FIGS. 3 and 4, only the antenna line in the range shown as the antenna element portion 27-1 operates as an antenna.

Although the high-frequency separation element 221 is provided in the switch 22 in the earphone antenna 20 illustrated in FIG. 4, but instead of it, a high-frequency separation element may be provided in the earphone jack portion 24.

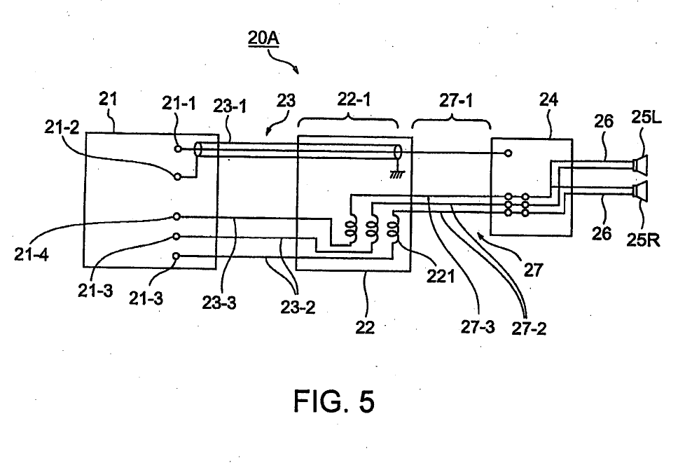

Referring to FIG. 5, an earphone antenna 20A according to a second embodiment of this invention will be described. Except that an outer conductor of a coaxial cable 23-1 is grounded to a circuit board 22-1 of a switch 22, the illustrated earphone antenna 20A is similar in structure and operation to the earphone antenna 20 illustrated in FIG. 4. Therefore, the same reference symbols are assigned to those having the same functions as those illustrated in FIG. 4 and only the difference will hereinbelow be described for brevity of description.

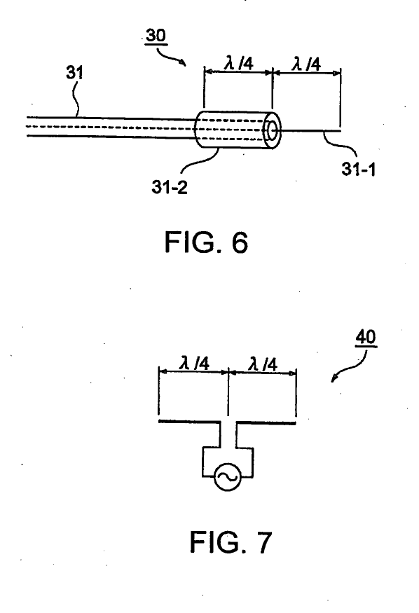

In theory, the earphone antenna 20A illustrated in FIG. 5 operates in the same manner as a sleeve antenna 30 illustrated in FIG. 6.

That is, the sleeve antenna 30 illustrated in FIG. 6 has a configuration comprising a core 31-1 and a sheath conductor 31-2 of a coaxial line 31 with the sheath conductor 31-2 being turned inside out (folded back) and operates in the same manner as a dipole antenna 40 illustrated in FIG. 7. Herein, the length of the core 31-1 is equal to the quarter wavelength (λ/4) and the length of the turned-over sheath conductor 31-2 is also equal to the quarter wavelength (λ/4).

In the earphone antenna 20A illustrated in FIG. 5, an antenna element portion 27-1 corresponds to the core 31-1 of the sleeve antenna 30 and the circuit board 22-1 of the switch 22 corresponds to the turned-over sheath conductor 31-2 of the sleeve antenna 30. The reason is that the antenna element portion 27-1, as it is, obviously corresponds to the core 31-1 illustrated in FIG. 6 and the outer conductor of the coaxial cable 23-1 is ground-connected to the circuit board 22-1 of the switch 22. In this case, the length of the antenna element portion 27-1 and the length of the circuit board 22-1 from a ground-connected point are each equal to about λ/4. Therefore, the circuit board 22-1 corresponds to the folded-back sheath conductor 31-2 of the sleeve antenna 30 illustrated in FIG. 6.

Naturally, both antennas differ from each other in appearance because the folded-back sheath conductor 31-2 is tubular in the sleeve antenna 30 while what corresponds thereto is the circuit board 22-1 in the earphone antenna 20A illustrated in FIG. 5. However, in terms of equivalent circuits, the sleeve antenna 30 illustrated in FIG. 6 and the earphone antenna 20A illustrated in FIG. 5 are equivalent to each other and thus operate as antennas equivalent in operating principle.

Therefore, the earphone antenna 20A illustrated in FIG. 5 and the earphone antenna 20 illustrated in FIG. 4 operate as antennas with different principles.

With the configuration of the earphone antenna 20A described above, it is also possible to efficiently receive a radio wave in the UHF band. As compared with the earphone antenna 20 illustrated in FIG. 4, the earphone antenna 20A illustrated in FIG. 5 is the same in appearance except that the outer conductor of the coaxial cable 23-1 is ground-connected to the circuit board 22-1. Therefore, in the form of finished products, since the ground-connected portion of the coaxial cable 23-1 is accommodated in a case of the switch 22 or the like along with the circuit board 22-1, it is impossible to distinguish in appearance between the earphone antenna 20A and the earphone antenna 20.

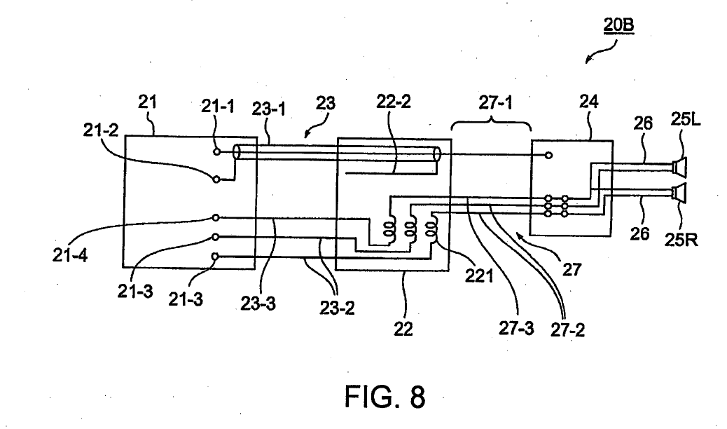

Referring to FIG. 8, an earphone antenna 20B according to a third embodiment of this invention will be described. Except that one end of an additional cable 22-2 is connected to the tip of an outer conductor of a coaxial cable 23-1 instead of ground-connecting the outer conductor of the coaxial cable 23-1 to the circuit board of the switch 22, the illustrated earphone antenna 20B is similar in structure and operation to the earphone antenna 20A illustrated in FIG. 5. Therefore, the same reference symbols are assigned to those having the same functions as those illustrated in FIG. 5 and only the difference will hereinbelow be described for brevity of description.

The additional cable 22-2 is disposed so as to be oriented toward the side of a connector 21. In this case, the cable length of the additional cable 22-2 is about λ/4.

In the illustrated earphone antenna 20B, the newly provided additional cable 22-2 corresponds to the folded-back portion 31-2 of the sheath conductor of the sleeve antenna 30. Therefore, a sleeve antenna can also be formed with the configuration of the earphone antenna 20B.

Although the example of forming the sleeve antenna is shown with respect to each of the earphone antennas 20A and 20B according to the foregoing second and third embodiments, the technique of forming a sleeve antenna is naturally not limited thereto. For example, even using a metal plate or the like instead of the additional cable 22-2 in the earphone antenna 20B according to the third embodiment of this invention, a sleeve antenna can be similarly formed and it is possible to obtain the same effect.

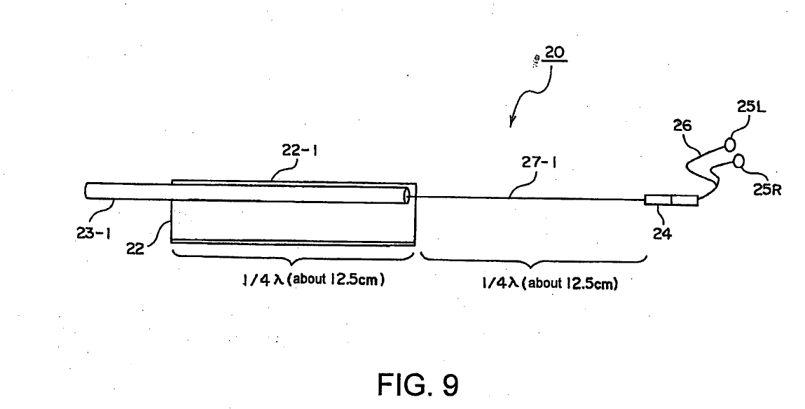

In each of the earphone antennas 20, 20A, and 20B according to the foregoing first to third embodiments of this invention, the antenna element portion 27-1 is provided outside the switch 22 as illustrated in FIG. 9. Accordingly, the antenna element portion 27-1 has a length equal to the quarter wavelength, i.e. about 12.5 cm, and the circuit board 22-1 of the switch 22 also has a length equal to the quarter wavelength, i.e. about 12.5 cm.

However, part of the antenna element portion may be disposed inside the switch as in each of later-described embodiments.

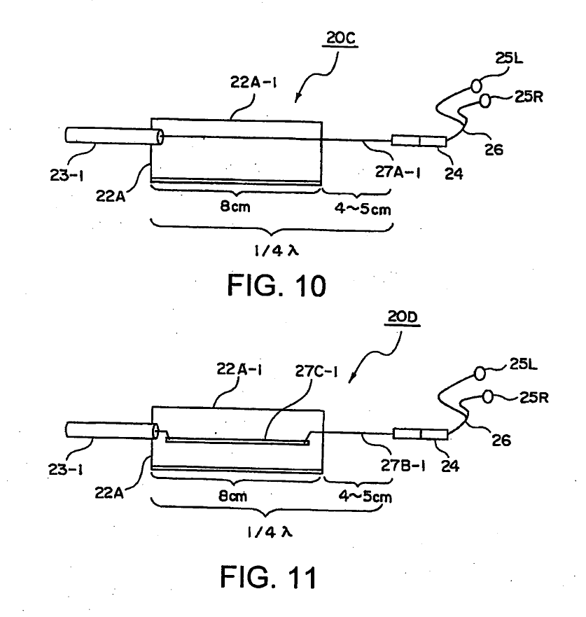

Referring to FIG. 10, an earphone antenna 20C according to a fourth embodiment of this invention will be described. In FIG. 10, only the main part of the earphone antenna 20C is illustrated and non-illustrated components are similar as those illustrated in FIG. 4.

The illustrated earphone antenna 20C is similar in structure to the earphone antenna 20 illustrated in FIGS. 4 and 9 except that part of an antenna element portion is disposed inside a switch. Accordingly, reference symbols of 27A-1 and 22A are assigned to the antenna element portion and the switch, respectively.

In the earphone antenna 20 illustrated in FIGS. 4 and 9, the axial cable 23-1 is placed on the circuit board 22-1 of the switch 22. Therefore, the antenna element portion 27-1 and the circuit board 22-1 each have the length equal to the quarter wavelength, i.e. about 12.5 cm.

On the other hand, in the earphone antenna 20C illustrated in FIG. 10, part of the antenna element portion 27A-1 is disposed so as to extend into the inside of the switch 22A. The antenna element portion 27A-1 has a length equal to the quarter wavelength, i.e. about 12.5 cm, which is equal to that of the antenna element portion 27-1. Therefore, the length (size) of a circuit board 22A-1 of the switch 22A can be made shorter (smaller) than the length (size) of the circuit board 22-1 of the switch 22.

In the earphone antenna 20C illustrated in FIG. 10, the length of a part, located outside the switch 22A, of the antenna element portion 27A-1 is 4 to 5 cm and the length of a part, accommodated inside the switch 22A, of the antenna element portion 27A-1 is about 8 cm. Therefore, the length of the circuit board 22A-1 of the switch 22A becomes 8 cm.

The antenna element portion 27A-1 may be formed by a simple extension of a center conductor of a coaxial cable 23-1.

Referring to FIG. 11, an earphone antenna 20D according to a fifth embodiment of this invention will be described. The illustrated earphone antenna 20D is similar in structure to the earphone antenna 20C illustrated in FIG. 10 except that an antenna element portion is modified as will be described later.

That is, in the earphone antenna 20C illustrated in FIG. 10, the antenna element portion 27A-1 is formed by a single core with no difference between the inside and the outside of the switch 22A. On the other hand, in the earphone antenna 20D illustrated in FIG. 11, the antenna element portion comprises a first antenna element part 27B-1 located outside a switch 22A and a second antenna element part 27C-1 disposed inside the switch 22A. Further, the second antenna element part 27C-1 is in the form of a pattern formed on a circuit board 22A-1. Therefore, one end of the pattern 27C-1 is connected to one end of the first antenna element part 27B-1 and the other end of the pattern 27C is connected to a center conductor of a coaxial cable 23-1.

In the earphone antenna 20D illustrated in FIG. 11, the length of the first antenna element part 27B-1 is 4 to 5 cm and the length of the pattern (second antenna element part) 27C-1 is about 8 cm. Therefore, the length of the circuit board 22A-1 of the switch 22A becomes 8 cm.

At any rate, in each of the earphone antennas 20C and 20D according to the fourth and fifth embodiments of this invention, the size (length) of the circuit board 22A-1 of the switch 22A can be made smaller (shorter) than the size (length) of the circuit board 22-1 of the switch 22 in each of the earphone antennas 20, 20A, and 20B according to the first to third embodiments of this invention.

While this invention has been described in terms of the preferred embodiments, this invention is of course not limited to the foregoing embodiments. For example, although one end of the third cable 27 is fixed to the switch 22 in each of the foregoing first to third embodiments, the third cable may have a plug and the switch may have a jack for connection to the plug.

1. An earphone antenna (20; 20A; 20B; 20C; 20D) comprising a connector (21) for connection to an electronic device, a switch (22; 22A), an earphone (25R, 25L), a first cable (23) connecting said connector and said switch to each other, and a connecting member connecting said switch and said earphone to each other, said earphone antenna characterized in that
said connecting member comprises an earphone jack portion (24), a second cable (26) connecting said earphone jack portion and said earphone to each other, and a third cable (27) connecting said switch and said earphone jack portion to each other and said third cable is used as an antenna.

2. An earphone antenna according to claim 1, characterized in that said first cable (23) includes a coaxial cable (23-1) for transmitting a received signal, said third cable (27) includes an antenna element portion (27-1; 27A-1; 27B-1, 27C-1) having one end connected to a center conductor of said coaxial cable, and said antenna element portion has a length (λ/4) substantially equal to a quarter of a wavelength of a radio wave to be received.

3. An earphone antenna according to claim 2, wherein said radio wave to be received is in a UHF band.

4. An earphone antenna according to claim 2, characterized in that said switch (22) comprises a circuit board (22-1) receiving said coaxial cable, an outer conductor of said coaxial cable is ground-connected to said circuit board, and said circuit board has, from a ground-connected point, a length substantially equal to a quarter of the wavelength of the radio wave to be received.

5. An earphone antenna according to claim 2, characterized in that said switch (22) comprises an additional cable (22-2) having one end connected to an outer conductor of said coaxial cable and said additional cable has a length substantially equal to a quarter of the wavelength of the radio wave to be received.

6. An earphone antenna according to claim 2, characterized in that said switch (22) comprises a metal plate having one end connected to an outer conductor of said coaxial cable and said metal plate has a length substantially equal to a quarter of the wavelength of the radio wave to be received.

7. An earphone antenna according to claim 2, characterized in that said switch (22A) comprises a circuit board (22A-1) and part of said antenna element portion (27A-1; 27B-1, 27C-1) extends on said circuit board.

8. An earphone antenna according to claim 7, wherein the part (27C-1) of said antenna element portion on said circuit board (22A-1) is a pattern formed on said circuit board.
